(19) United States
(12) Patent Application Publication
(10) Pub. No.: US 2015/0083351 A1
(43) Pub. Date: Mar. 26, 2015

(54) SHADE MOTOR WITH LATCH ASSEMBLY AND BRACKET

(71) Applicant: Crestron Electronics, Inc., Rockleigh, NJ (US)

(72) Inventor: Michael Campagna, Woodcliff Lake, NJ (US)

(73) Assignee: Crestron Electronics, Inc., Rockleigh, NJ (US)

(21) Appl. No.: 14/494,958

(22) Filed: Sep. 24, 2014

Related U.S. Application Data
(60) Provisional application No. 61/881,583, filed on Sep. 24, 2013.

(51) Int. Cl. E06B 9/68; E06B 9/44

(52) U.S. Cl. CPC E06B 9/68; E06B 9/44
USPC 160/310; 29/468

(57) ABSTRACT

Presented is a roller shade motor system that includes a motor with an end portion, a latch assembly disposed on the end portion, and a bracket. The latch assembly includes an alignment member and at least one moveable clip. The bracket includes a clip contact surface and defines an alignment member opening dimensioned and arranged for receiving the alignment member. The moveable clip is retracted into the alignment member during insertion of the alignment member into the alignment member opening and is extended out of the alignment member and contacts the clip contact surface after insertion and couples the motor to the bracket.

### BACKGROUND OF THE INVENTION

1. Technical Field

The present disclosure relates generally to roller shade motors, and more particularly to a system and method for quickly and easily coupling/decoupling a roller shade motor to/from a mounting bracket.

2. Background Art

Typically, to mount a roller shade motor to a wall, the shade motor must be coupled to a mounting bracket. Existing methods for coupling a shade motor to a mounting bracket include attaching a cleat to the shade motor and coupling the cleat to the mounting bracket, or coupling the shade motor directly to the mounting bracket using screws. Both methods are cumbersome and time consuming.

### SUMMARY OF THE INVENTION

It is to be understood that both the general and detailed descriptions that follow are exemplary and explanatory only and are not restrictive of the invention.

### Disclosure of the Invention

According to one aspect, the invention involves a roller shade motor system. The roller shade motor system includes a roller shade motor that includes an end portion, a latch assembly disposed on the end portion, and a bracket. The latch assembly includes an alignment member and at least one moveable clip. The bracket includes a clip contact surface and defines an alignment member opening dimensioned and arranged for receiving the alignment member therein. The at least one moveable clip is retracted into the alignment member during insertion of the alignment member into the alignment member opening and is extended out of the alignment member and contacts the clip contact surface after insertion of the alignment member into the alignment member opening and thereby couples the roller shade motor to the bracket.

In one embodiment, the latch assembly includes a keying tab disposed on one side of the alignment member. In another embodiment, the bracket defines a keying slot dimensioned and arranged for receiving the keying tab therein when the alignment member is disposed in the alignment member opening. In still another embodiment, the latch assembly includes a latch release button configured for retracting the at least one moveable clip into the alignment member when pressed and allowing the at least one moveable clip to extend out of the alignment member when released. In yet another embodiment, the at least one moveable clip includes a sloped surface dimensioned and arranged to enable the at least one moveable clip to be pushed into the alignment member when the sloped surface contacts an edge of the alignment member opening while the alignment member is being pushed into the alignment member opening.

According to another aspect, the invention involves a roller shade motor coupling system. The latching system includes a latch assembly configured for attaching to an end portion of a roller shade motor, and a bracket. The latch assembly includes an alignment member and at least one moveable clip. The bracket includes a clip contact surface and defines an alignment member opening dimensioned and arranged for receiving the alignment member therein. The at least one moveable clip is retracted into the alignment member during insertion of the alignment member into the alignment member opening and is extended out of the alignment member and contacts the clip contact surface after insertion of the alignment member into the alignment member opening and thereby couples the latch assembly to the bracket.

In one embodiment, the latch assembly includes a keying tab disposed on one side of the alignment member. In another embodiment, the bracket defines a keying slot dimensioned and arranged for receiving the keying tab therein when the alignment member is disposed in the alignment member opening. In still another embodiment, the latch assembly includes a latch release button configured for retracting the at least one moveable clip into the alignment member when pressed and allowing the at least one moveable clip to extend out of the alignment member when released. In yet another embodiment, the at least one moveable clip includes a sloped surface dimensioned and arranged to enable the at least one moveable clip to be pushed into the alignment member when the sloped surface contacts an edge of the alignment member opening while the alignment member is being pushed into the alignment member opening.

According to another aspect, the invention involves a method of coupling a roller shade motor to a bracket. The method includes providing a motor that includes a latch assembly that includes an alignment member, at least one moveable clip, and a latch release button configured for retracting the at least one moveable clip into the alignment member when pressed and allowing the at least one moveable clip to extend out of the alignment member when released. The method further includes providing a bracket that includes a clip contact surface and defines an alignment member opening dimensioned and arranged for receiving the alignment member therein. The method further includes pressing the latch release button to retract the at least one moveable clip into the alignment member, inserting the alignment member into the alignment member opening, and releasing the latch release button to extend the at least one moveable clip out of the alignment member and contact the clip contact surface and thereby couple the roller shade motor to the bracket.

### BRIEF DESCRIPTION OF THE DRAWINGS

The accompanying figures further illustrate the present invention. Exemplary embodiments are illustrated in reference figures of the drawings. It is intended that the embodiments and figures disclosed herein are to be considered to illustrative rather than limiting.

The components in the drawings are not necessarily drawn to scale, emphasis instead being placed upon clearly illustrating the principles of the present invention. In the drawings, like reference numerals designate corresponding parts throughout the several views.

FIG. 1 is an illustrative isometric view of a roller shade motor including a latch assembly with moveable clips in an extended position and decoupled from a mounting bracket, according to one embodiment of the invention.

FIG. 2 is an illustrative isometric view of a roller shade motor including a latch assembly with moveable clips in a retracted position and decoupled from a mounting bracket, according to one embodiment of the invention.

FIG. 3 is an illustrative isometric view of a roller shade motor including a latch assembly with moveable clips in a retracted position and coupled to a mounting bracket, according to one embodiment of the invention.

FIG. 4 is an illustrative isometric view of a roller shade motor including a latch assembly with moveable clips in an extended position and coupled to a mounting bracket, according to one embodiment of the invention.

FIG. 5 is an illustrative flow diagram of the steps for coupling a roller shade motor with latch assembly to a mounting bracket, according to one embodiment of the invention.

### LIST OF REFERENCE NUMBERS FOR THE MAJOR ELEMENTS IN THE DRAWING

The following is a list of the major elements in the drawings in numerical order.
102 roller shade motor
104 motor bracket
106 latch assembly
108 alignment member
110 keying tab
112 keying slot
114 alignment member opening
116 through hole
118a moveable clip
118b moveable clip
120 clip contact surface
122 latch release button
124 end portion
126 surface
128 gap
130 sloped surface
132 edge
134 cavity
136 vertical portion
502 Insert gudgeon pin into gudgeon bracket
504 Press the latch release button to retract the clips into the alignment member
506 Insert the alignment member into the alignment member opening
508 Release the latch release button to extend the clips out of the alignment member

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### MODE(S) FOR CARRYING OUT THE INVENTION

Disclosed are a system and method for quickly and easily coupling/decoupling a roller shade motor to/from a mounting bracket.

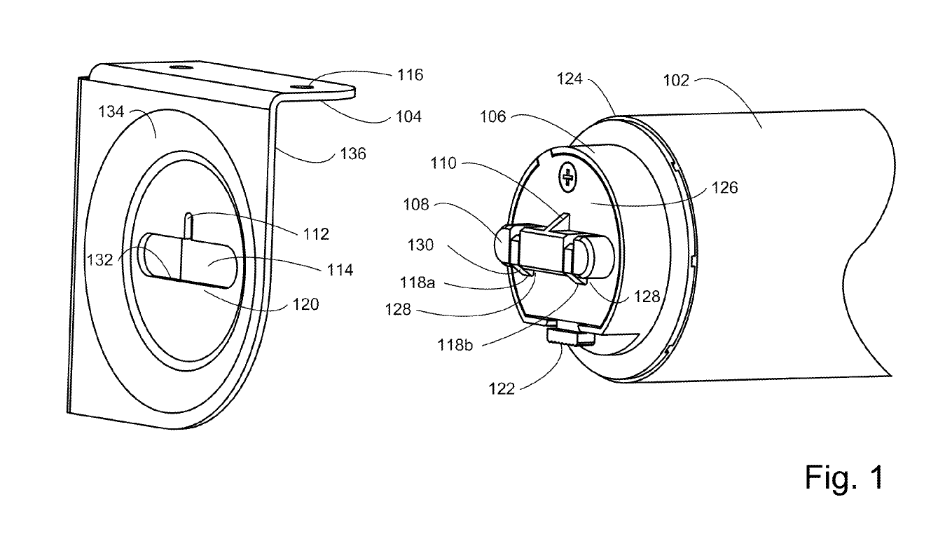

Referring to FIG. 1, in one embodiment, a roller shade motor system is shown. The system includes a motor bracket 104 and roller shade motor 102 with a latch assembly 106. The bracket 104 defines two or more mounting through holes 116, an alignment member opening 114, and a keying slot 112. The bracket 104 also includes a clip contact surface 120. The latch assembly 106 is coupled to (or integrated with/part of) an end portion 124 of the roller shade motor 102. The latch assembly 106 includes an alignment member 108, a keying tab 110, moveable clips 118a, 118b, and a spring-loaded latch release button 122.

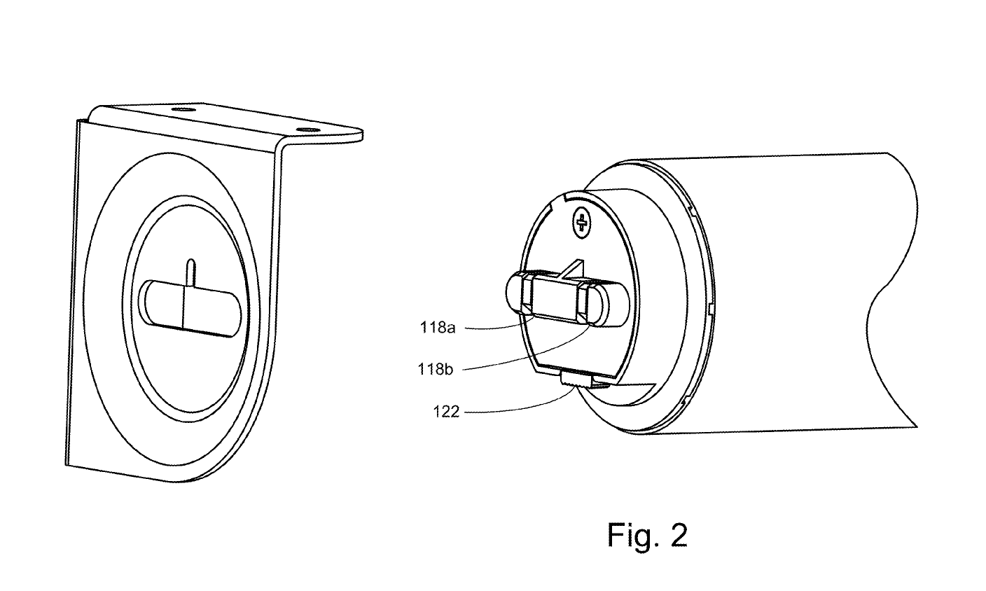

When the latch release button 122 is in an unpressed state, the clips 118a, 118b extend downward out of the alignment member 108 (latch closed), as shown in FIG. 1. When the latch release button 122 is in a pressed state, the clips 118a, 118b retract into the alignment member 108 (latch open), as shown in FIG. 2. When the latch release button 122 is released (from being pressed), the clips 118a, 118b again extend out of the alignment member 108.

In one embodiment, in operation, the motor bracket 104 is mounted on one side above a window or inside a window box using screws disposed through the plurality of through holes 116. A gudgeon bracket (not shown) is mounted on the opposite side above the window or inside the window box using means similar to the means used for mounting the motor bracket 104. The gudgeon bracket is dimensioned and arranged to couple to, or receive, a spring-loaded gudgeon, a description of which is beyond the scope of this disclosure. The shade motor 102 is partially disposed inside one end of a roller shade roller tube (not shown). A spring loaded gudgeon assembly (not shown) is partially disposed inside the other end of the roller shade roller tube.

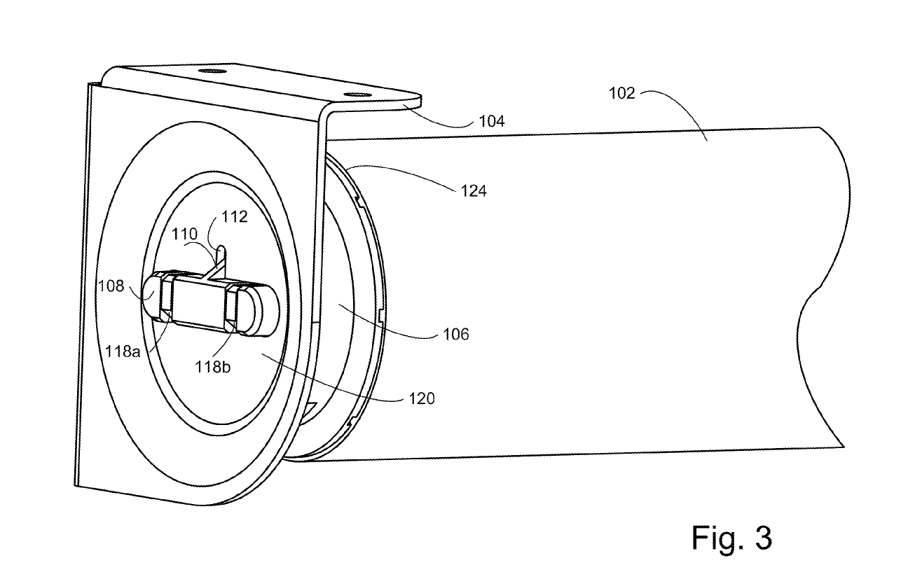

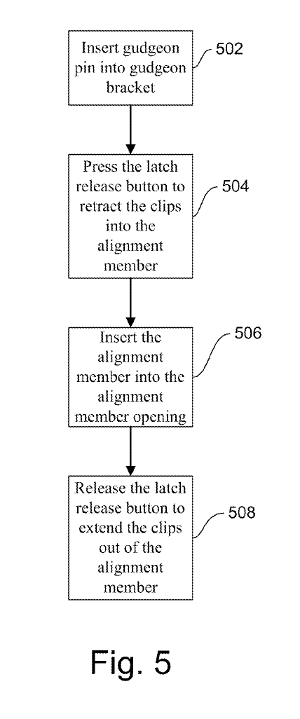

Referring to FIG. 5, in one embodiment, to mount the roller shade over the window, a gudgeon pin (not shown) of the gudgeon assembly is first inserted into the gudgeon bracket (Step 502). Next, the latch release button 122 of the latch assembly 106 is pressed and the clips 118a and 118b retract into the alignment member 108 (Step 504). The alignment member 108 is inserted into the alignment member opening 114 of the bracket 104, with the keying tab 110 oriented to slide into the keying slot 112, as shown in FIG. 3 (Step 506). It should be noted that the spring-loaded gudgeon allows for lateral translation of the roller shade roller tube during insertion of the alignment member 108 into the alignment member opening 114.

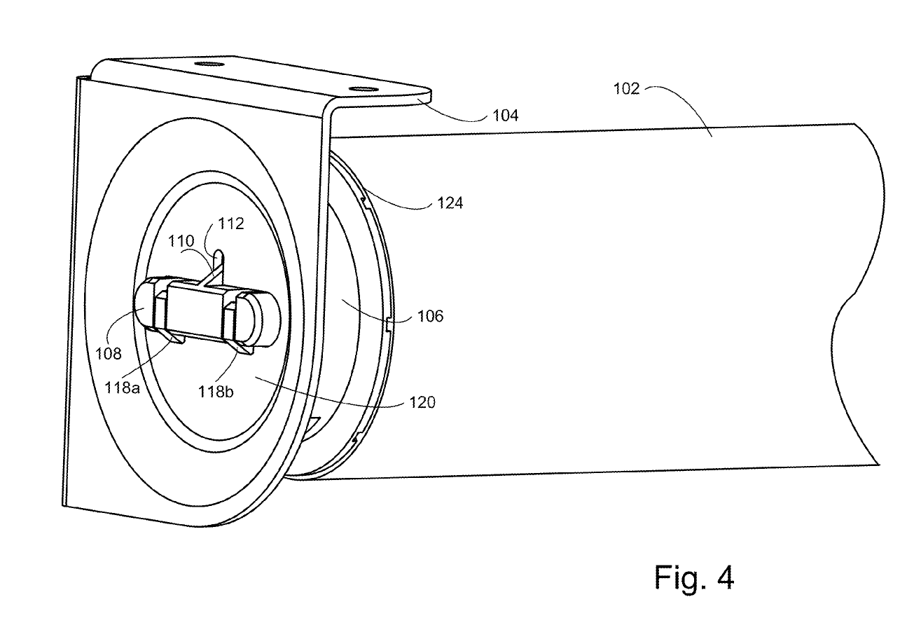

After the alignment member 108 has been inserted into the alignment member opening 114, the latch release button 122 is released and the clips 118a and 118b again extend out of the alignment member 108, contact the clip contact surface 120, and lock the alignment member 108 in place, thereby coupling the motor 102 to the bracket 104, as shown in FIG. 4 (Step 508). In other words, the motor 102 (and latch assembly 106) is prevented from separating/detaching from the bracket 104. It should be noted that a gap 128 exists between each of the clips 118a and 118b and the surface 126 of the latch assembly 106. The gap 128 is only as wide as the thickness of the bracket 104 proximate to the alignment member opening 114 to allow the clips 118a and 118b enough room to extend out of the alignment member 108 and contact the bracket surface 120 when the alignment member 108 is in the alignment member opening 114 and the latch surface 126 is flush with the bracket 104 (see FIG. 4).

It should also be noted that the alignment member opening 114 is disposed in a cavity 134 (see FIG. 1) and thus offset from the vertical portion 136 of the bracket 104 (i.e., the part of the bracket that contacts a wall) by a distance that is slightly greater than the distance the alignment member 108 protrudes through the alignment member opening 114. This allows for the bracket 104 to be mounted flush against a wall while allowing the latch assembly 106 to couple to the bracket 104 properly.

In another embodiment, the alignment member 108 is pushed into the alignment member opening 114 without first pressing the latch release button 122. The clips 118a and 118b have sloped or angled (see FIGS. 1 and 3) surfaces 130. As the alignment member 108 is pushed into/through the alignment member opening 114, the sloped surfaces 130 of the clips 118a, 118b contact an edge 132 of the alignment member opening 114 and the clips 118a, 118b are pushed/forced to slide (retract) into the alignment member 108. Once the alignment member 108 is pushed far enough through the alignment member opening 114, the clips 118a, 118b automatically (via spring-loading) extend out of the alignment member 108, contact the clip contact surface 120, and lock the alignment member 108 in place, thereby coupling the motor 102 to the bracket 104, as shown in FIG. 4. In other words, the motor 102 (and latch assembly 106) is prevented from separating/detaching from the bracket 104.

The motor 102 is easily detached/decoupled from the motor bracket 104 by pressing the latch release button 122, which pushes the clips 118a, 118b into the alignment member 108. Once the clips 118a, 118b have been retracted into the alignment member 108, the alignment member 108 can be pulled out of the alignment member opening 114.

In various embodiments, the various parts of the above-described system are made of plastic, fiberglass, aluminum, or stainless steel, or any other suitable material known to those skilled in the art.

In yet another embodiment, the latch assembly described above is separate from (rather than integrated with/part of) the shade motor. In this embodiment, the latch assembly is configured to attach/couple to a wide variety of shade motors using methods known to those skilled in the art (e.g., via screws, friction fit, adhesives). In this embodiment, the latch assembly and bracket can be used with existing shade motors.

### ALTERNATE EMBODIMENTS

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A roller shade motor system, comprising:
a roller shade motor comprising an end portion;
a latch assembly disposed on the end portion, the latch assembly comprising an alignment member and at least one moveable clip; and
a bracket comprising a clip contact surface and defining an alignment member opening dimensioned and arranged for receiving the alignment member therein, the at least one moveable clip being retracted into the alignment member during insertion of the alignment member into the alignment member opening and being extended out of the alignment member and contacting the clip contact surface after insertion of the alignment member into the alignment member opening and thereby coupling the roller shade motor to the bracket.

2. The system of claim 1, wherein the latch assembly comprises a keying tab disposed on one side of the alignment member.

3. The system of claim 2, wherein the bracket defines a keying slot dimensioned and arranged for receiving the keying tab therein when the alignment member is disposed in the alignment member opening.

4. The system of claim 1, wherein the latch assembly comprises a latch release button configured for retracting the at least one moveable clip into the alignment member when pressed and allowing the at least one moveable clip to extend out of the alignment member when released.

5. The system of claim 1, wherein the at least one moveable clip comprises a sloped surface dimensioned and arranged to enable the at least one moveable clip to be pushed into the alignment member when the sloped surface contacts an edge of the alignment member opening while the alignment member is being pushed into the alignment member opening.

6. A roller shade motor coupling system, comprising:
a latch assembly configured for coupling to an end portion of a roller shade motor, the latch assembly comprising an alignment member and at least one moveable clip; and
a bracket comprising a clip contact surface and defining an alignment member opening dimensioned and arranged for receiving the alignment member therein, the at least one moveable clip being retracted into the alignment member during insertion of the alignment member into the alignment member opening and being extended out of the alignment member and contacting the clip contact surface after insertion of the alignment member into the alignment member opening and thereby coupling the latch assembly to the bracket.

7. The system of claim 6, wherein the latch assembly comprises a keying tab disposed on one side of the alignment member.

8. The system of claim 7, wherein the bracket defines a keying slot dimensioned and arranged for receiving the keying tab therein when the alignment member is disposed in the alignment member opening.

9. The system of claim 6, wherein the latch assembly comprises a latch release button configured for retracting the at least one moveable clip into the alignment member when pressed and allowing the at least one moveable clip to extend out of the alignment member when released.

10. The system of claim 6, wherein the at least one moveable clip comprises a sloped surface dimensioned and arranged to enable the at least one moveable clip to be pushed into the alignment member when the sloped surface contacts an edge of the alignment member opening while the alignment member is being pushed into the alignment member opening.

11. A method of coupling a roller shade motor to a bracket, the method comprising:
providing a motor comprising a latch assembly comprising an alignment member, at least one moveable clip, and a latch release button configured for retracting the at least one moveable clip into the alignment member when pressed and allowing the at least one moveable clip to extend out of the alignment member when released;
providing a bracket comprising a clip contact surface and defining an alignment member opening dimensioned and arranged for receiving the alignment member therein;
pressing the latch release button to retract the at least one moveable clip into the alignment member;
inserting the alignment member into the alignment member opening; and
releasing the latch release button to extend the at least one moveable clip out of the alignment member and contact the clip contact surface and thereby couple the roller shade motor to the bracket.
